(19) United States
(12) Patent Application Publication
(10) Pub. No.: US 2002/0121081 A1
(43) Pub. Date: Sep. 5, 2002

(54) Liquid/solid fuel hybrid propellant system for a rocket

(75) Inventors: Anthony J. Cesaroni, Gormley (CA); Michael J. Dennett, Orangeville (CA)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Cesaroni Technology Incorporated

(21) Appl. No.: 10/044,473

(22) Filed: Jan. 10, 2002

Related U.S. Application Data
(60) Provisional application No. 60/260,697, filed on Jan. 10, 2001.

(51) Int. Cl. F02K 9/72

(52) U.S. Cl. 60/251; 60/39.462

(57) ABSTRACT

A hybrid propulsion system comprises a liquid fuel section and a solid fuel section. The liquid fuel section contains an aqueous solution of hydrogen peroxide. An injector system is located between the liquid fuel section and the solid fuel section. The injector system injects a stream of hydrogen peroxide or a decomposed stream of hydrogen peroxide at elevated temperatures into the solid fuel section to effect combustion of the fuel grain in the solid fuel section.

### FIELD OF THE INVENTION

The present invention relates to propellant systems, and especially propellant systems for combined liquid/solid propellant rockets which are more particularly referred to as hybrid rockets. In particular, the present invention relates to hybrid propellant systems utilizing aqueous solutions of hydrogen peroxide, optionally including additional oxidizing materials in solution or in suspension, especially high-performance oxidizers such as ammonium dinitramide (ADN) or hydrazinium nitroformate (HNF).

### BACKGROUND OF THE INVENTION

Hybrid propulsion systems utilizing gaseous and liquid oxidizers have been demonstrated. Hybrid propulsion systems offer numerous potential advantages over solid or liquid propulsion systems. Some potential benefits include high mass fraction, low cost, rapid deployment, reduced storage and transportation restrictions, throttling ability, and configurable thrust and mission profiles.

Several proposals have been made in the aerospace industry on alternate propulsion concepts for low-cost rocket vehicles, primarily for space launch applications. One such proposal relates to a hybrid propulsion system using solid aluminum fuel grains with water as the oxidizing agent. The reaction of water and aluminum is highly energetic, yielding alumina and hydrogen at temperatures exceeding 3000° K. Theoretical specific impulse (Iₛₚ) for such a reaction under standard conditions is reported as 257 lbf-s/lbm.

There are a number of advantages of such a system, as the fuel grains could be easily manufactured and both reactants are abundant and economical. However, efficiency is likely to present difficulties, in that aluminum has a propensity for incomplete combustion and there is a high percentage of condensable products from such a reaction which could adversely affect the delivered performance. Start-up schemes may prove challenging. Moreover, the fuel volume fraction at stoichiometric oxidizer to fuel ratios and structural requirements of the combustion chamber may negatively impact mass fraction and reduce or eliminate potential benefits.

Other current avenues of research involve high purity H₂O₂ in liquid bipropellant systems. Hydrogen peroxide in concentrations of 50% to 98% by weight is available commercially. 70% hydrogen peroxide yields over 20% by weight of free oxygen upon decomposition to H₂O and O₂. The decomposition reaction of 70% hydrogen peroxide by itself yields a theoretical specific impulse (Isp) at standard conditions of over 120 lbf-s/lbm with reaction products at a temperature of approximately 1380° K. Techniques and materials used to accomplish decomposition of H₂O₂ in monopropellant systems are known to those skilled in the art.

The use of gas generator fuel grains, which are essentially oxidizer deficient solid propellants, has demonstrated excellent combustion efficiency in hybrid propulsion systems. Such compositions are also known to those skilled in the art.

Hydrogen peroxide has been in use as a monopropellant and as a liquid oxidizer in liquid bi-propellant systems for many years and its use therefor is well known to those skilled in the art. Pure hydrogen peroxide decomposes violently into superheated steam and oxygen in contact with a suitable catalyst. Aqueous solutions of hydrogen peroxide decompose in a similar manner with additional quantities of water being present in the decomposition products in direct correlation to the concentration of the solution. In both mono and liquid bipropellant systems, the water takes the form of superheated steam which becomes part of the working fluid ejected in the exhaust stream of the motor.

Traditionally, water is not considered a reactant in such propulsion systems due to its chemical stability. It is known to those skilled in the art that water can react exothermally with various metals and metal hydrides whereby the water is decomposed into hydrogen and oxygen, said oxygen reacting with the metal resulting in the liberation of metal oxide, hydrogen and heat energy.

According to preferred aspects of the invention, a feature of the invention is the use of the oxygen liberated by the decomposition of hydrogen peroxide for combustion of a solid fuel grain in a hybrid configuration. Another feature of an aspect of the invention is further reaction of the water in the hydrogen peroxide decomposition products, with hydro-reactive materials in the fuel grain to liberate additional heat energy and working fluid. The result is a substantial performance gain over hydrogen peroxide monopropellant systems, or hybrid systems utilizing decomposed hydrogen peroxide and a fuel without hydro-reactive materials.

### SUMMARY OF THE INVENTION

A hybrid propulsion system comprising:

a liquid fuel section containing an aqueous solution of hydrogen peroxide and a solid fuel section containing a fuel grain; and

an injector system located between the liquid fuel section and the solid fuel section, said injector system injecting a stream of hydrogen peroxide or decomposed hydrogen peroxide into the solid fuel section to effect combustion of the fuel grain.

In preferred embodiments of the invention, the hydrogen peroxide is at a concentration of 50-98 percent by weight, and especially a concentration in the range of 70-90 percent by weight.

In other preferred embodiments, the injector system will effect decomposition of the hydrogen peroxide. The injector may contain a catalyst for decomposition of hydrogen peroxide or the injector system may effect decomposition of hydrogen peroxide by heat.

In other embodiments, the aqueous solution of hydrogen peroxide additionally contains a soluble or suspended oxidizer, especially ammonium perchlorate or ammonium nitrate, or other chlorate, nitrate or perchlorate salts.

In other embodiments, the aqueous solution of hydrogen peroxide may additionally contain a stabilizer or stabilizers such as a chelating agent which improve storage stability of the solution.

In further embodiments, the aqueous solution of hydrogen peroxide may additionally contain at least one of ammonium dinitramide and hydrazinium nitroformate, especially in an amount in the range of 5-50% by weight.

In still further embodiments, the fuel grain additionally contains a metal, especially a hydro-reactive metal and in particular a metal selected from the group consisting of aluminum, magnesium, boron, beryllium, lithium and silicon, and mixtures thereof. Hydrides of these metals are also useful in the invention.

In another embodiment, the fuel grain contains a solid oxidizer, especially a solid oxidizer selected from the group consisting of ammonium perchlorate, ammonium nitrate, other perchlorate, chlorate and nitrate salts, hydrazinium nitroformate and ammonium dinitramide.

In yet another embodiment, the fuel grain contains an energetic filler, especially an energetic filler selected from the group consisting of cyclotrimethylene trinitramine, cyclotetramethylene tetranitramine or hexanitroisoazowurzitane, and mixtures thereof.

In further embodiments, the fuel grain contains an energetic plasticizer, especially an energetic plasticizer selected from the group consisting of butanetriol trinitrate, trimethylolethane trinitrate, triethylene glycol dinitrate, glycidyl azide plasticizer, and mixtures thereof.

In other embodiments, the fuel grain contains an energetic polymer, especially an energetic polymer selected from the group consisting of glycidyl azide polymer, bis-azidomethyloxetane/azidomethyl-methoxetane copolymer and nitramethyl-methoxetane polymers, and mixtures thereof.

In further embodiments, the fuel grain contains ballistic or processing modifiers.

### BRIEF DESCRIPTION OF THE DRAWINGS

The present invention is illustrated by the embodiments shown in the drawings, in which:

FIG. 1 is a schematic representation of cross-section of a liquid/solid propulsion system; and

FIG. 2 is a schematic representation of a cross-section of a gas generator.

### DETAILED DESCRIPTION OF THE INVENTION

The present invention relates to a hybrid propulsion system based on an aqueous solution of hydrogen peroxide. In the present invention, it is preferred that the hydrogen peroxide has a concentration in the range of 50-98% by weight, and most especially a concentration in the range of 70-90% by weight. Aqueous solutions of hydrogen peroxide of such concentrations are commercially available, and some such solutions are used for instance in the pulp and paper industry.

High purity hydrogen peroxide is available in bulk at concentrations of up to approximately 90% by weight. It is possible to further concentrate the hydrogen peroxide, to concentrations that may reach as high as 98% by weight, but such high concentrations of hydrogen peroxide greatly increase the cost of the hydrogen peroxide and impose storage stability problems.

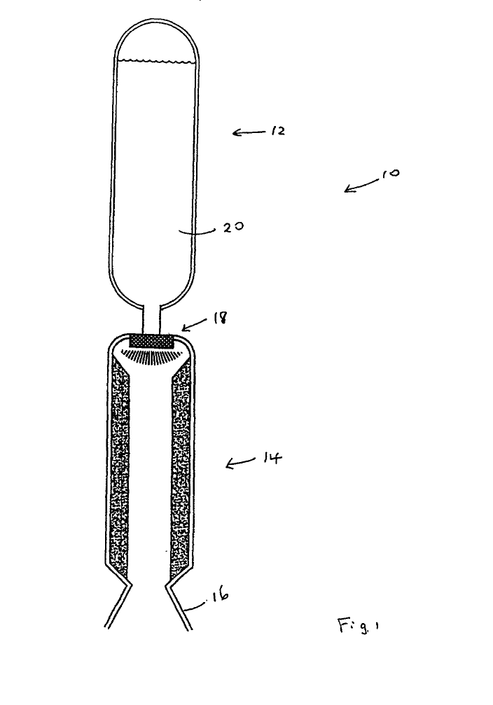

A hybrid rocket system is shown in FIG. 1, with the hybrid rocket being generally indicated by 10. Hybrid rocket 10 has liquid fuel section 12 and solid fuel section 14. Solid fuel section 14 terminates in nozzle 16. Liquid fuel section 12 and solid fuel section 14 are separated by a catalytic injector 18. Catalytic injectors are well known to those skilled in the art and have been commonly used in attitute control rockets, turbopump propulsion systems, etcetera. Liquid fuel section 12 contains liquid fuel 20, which would be a hydrogen peroxide propellant composition as described herein. Solid fuel section 14 contains a solid fuel, especially in the form of a fuel grain, and a wide variety of solid fuels may be used, also as discussed herein. Solid fuel 22 has annular passage 24.

In embodiments of the present invention, the aqueous solution may additionally contain a soluble or suspended high performance oxidizer, for instance at least one of ammonium dinitramide (ADN) and hydrozinium nitroformate (HNF). In particular, the aqueous solution may contain 5-50% by weight of ammonium dinitramide or hydrazinium nitroformate, or a mixture thereof. The aqueous solution may also contain other soluble or suspended oxidizers, for instance ammonium perchlorate (AP). Moreover, the aqueous solution may contain soluble or suspended energetic fillers, for instance cyclotrimethylene trinitramine (RDX), cyclotetramethylene tetranitramine (HMX) and/or hexanitroisoazowurzitane (CL-20).

If the aqueous solution is to be stored under low temperature conditions such that freezing of the solution might occur, the freezing point of the solution may be lowered by addition of low molecular weight alcohols or glycol e.g. methanol, ethanol or ethylene glycol. Other antifreeze agents may be used, providing that the use of the aqueous solution as a propellant is not adversely affected.

Hydrogen peroxide may be introduced into the solid fuel grain as follows:

1) through a catalytic injector bed, which results in superheated water and oxygen hitting the fuel grain, whatever its composition,

2) through an injector that causes the H₂O₂ to decompose via heat, with the same result as in #1, or

3) through an injector as undecomposed material, which would then decompose in contact with a suitable catalyst contained within the fuel grain. This may be an ambient temperature stream of H₂O₂ entering the fuel grain section.

One may decompose the H₂O₂ in the injector, then still add a little catalyst to the fuel grain if it is deemed desirable to effect better decomposition.

In the above embodiments, 1, 2 or 3, aqueous solutions of hydrogen peroxide may be delivered through the injector system 18 by any of a number of known means, including gas blow-down, pumps or other means.

In the injector system for embodiments 1 or 2, the hydrogen peroxide is decomposed at elevated temperatures by passage through the injector. For example, such temperatures could be in excess of 1000° K and especially in excess of 1300° K. Such decomposition provides a superheated stream of water and oxygen at elevated temperature, which is used in the combustion of the fuel grain that is in the solid fuel section of the hybrid propulsion system. Decomposition of the hydrogen peroxide may be accomplished as per embodiment #1, using a catalyst for the decomposition of hydrogen peroxide, the catalyst being located within the injector system. Examples of such catalysts include platinum and silver, and most preferably nickel or other suitable substrate coated with silver and samarium nitrate. The hydrogen peroxide may be decomposed within the injector system by using other means, for example heat as per embodiment 2. Combinations of such methods of decomposition may be used.

The solid fuel section of the rocket contains a fuel grain. In embodiments of the invention, the fuel grain is a thermosetting or thermoplastic polymer. Examples of thermosetting polymers include hydroxyl-terminated polybutadiene (HTPB) and polybutadiene acrylonitrile (PBAN). Examples of thermoplastic polymers include ethylene-vinyl acetate (EVA) copolymer and acrylonitrile-butadiene-styrene terpolymer (ABS). Other materials that may be used include waxes such as paraffin wax and microcrystalline wax.

In further embodiments of the invention, the fuel grain may contain a metal, especially a hydro-reactive metal, that will enhance specific impulse, combustion efficiency and/or enhance regression rate. Examples of such metals include aluminum, magnesium, boron, beryllium, lithium, silicon, mixtures thereof, and combinations of such metals with other metals. Other metals are known. The metals may be in the form of alloys, including combinations of the aforementioned aluminum, magnesium, boron, beryllium, lithium and silicon, and combinations of such metals with other metals. Hydrides of these metals are equally applicable. Metals and combinations of metals and metal hydrides used to enhance combustion efficiency and/or enhance regression rate are known to those skilled in the art.

In further embodiments of the fuel grain, the fuel grain contains a solid oxidizer. Examples of solid oxidizers include ammonium perchlorate (AP), ammonium nitrate (AN), hydrazinium nitroformate (HNF), ammonium dinitramide (ADN) and other solid or semi-solid oxidizers such as, hydroxylammonium nitrate (HAN), hydroxylammonium perchlorate (HAP) and nitronium perchlorate (NP).

In further embodiments, the fuel grain contains an energetic filler, examples of which are cyclotrimethylene trinitramine (RDX), cyclotetramethylene tetranitramine (HMX) or hexanitroisoazowurzitane (CL-20), and mixtures thereof. In addition, the fuel grain may contain an energetic plasticizer, examples of which are butanetriol trinitrate (BTTN), trimethylolethane trinitrate (TMETN), triethyleneglycol dinitrate (TEGDN) and glycidyl azide plasticizer (GAP plasticizer), and mixtures thereof.

The fuel grain may contain known modifiers to increase or decrease burn or regression rate, modify pressure sensitivity exponent, alter mechanical properties, modify plume signature, enhance processability and the like.

The fuel grain may be replaced in whole or in part by energetic polymers, examples of which are glycidyl azide polymer (GAP), bisazidomethyloxetane/azidomethylmethoxetane copolymer (BAMO/AMMO) and polynitramethylmethoxetane (poly NMMO).

A decomposition catalyst for hydrogen peroxide may also be included in the fuel grain. This catalyst may replace the inclusion of catalyst in the injector entirely, or it may supplement its action. Examples of such catalysts include potassium permanganate and manganese dioxide.

Suitable materials and processing techniques therefor are known for solid propellant compositions such as described in our co-pending application, entitled “Propellant System For Solid Fuel Rocket” filed Jan. 10, 2002 and given Ser. No. ______, and hybrid fuel compositions, and such systems are applicable to this invention, as are any others that may be selected or required by compatibility, performance, structural or other issues.

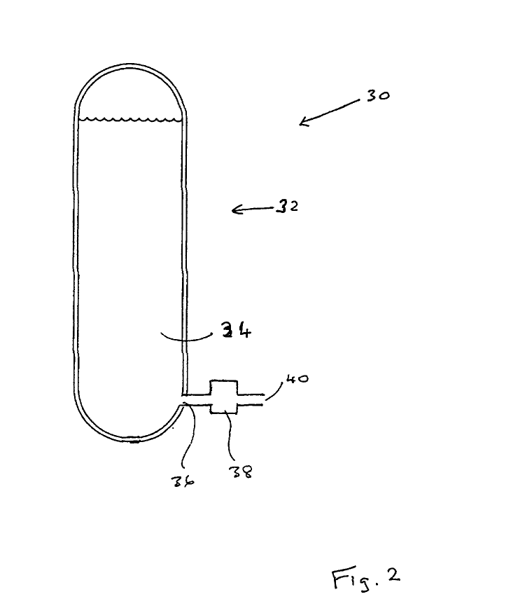

A gas generator system is shown in FIG. 2, and generally indicated by 30. Gas generator system 30 has liquid fuel section 32 that contains liquid fuel 34. Liquid fuel 34 is the aqueous solution of hydrogen peroxide, with optional additional components, as described herein. Liquid fuel section 32 has outlet 36 that is connected to catalytic injector system 38, which is turn connected to outlet 40. Catalytic injector system 38 contains a catalyst for generation of gas, that is, oxygen and steam from the hydrogen peroxide 34. Such gas is discharged from outlet 40, for use in any system that requires or utilizes the gas that is generated.

In the present invention, H₂O₂ is injected into the combustion chamber containing the fuel grain and decomposed, either though a catalyst bed, by incorporation of catalysts in the fuel grain composition, or through other means such as heat. The H₂O₂ decomposes into superheated steam and oxygen. The oxygen resulting from this decomposition reacts with the fuel grain to generate additional heat and working fluid. In addition, the use of hydro-reactive metals such as aluminum, magnesium and others or metal hydrides in the fuel grain will allow reaction with the superheated steam (water) to form H₂ and metal oxide. This energetic reaction further increases specific impulse. The conditions for this reaction are believed to be favourable in a hybrid oxygen/gas generator motor environment.

Specific impulse and/or density impulse may be increased by enhancing the hydrogen peroxide with water-soluble oxidizers or suspended solid oxidizers. Many high-performance oxidizers such as ADN and HNF are soluble in water and/or hydrogen peroxide. Solutions of this type generally show increased density over the base solution, thus enhancing density impulse. In addition, many sensitive materials show reduced sensitivity when wetted or in solution, and the system therefore may offer possibilities for deployment of otherwise unmanageable materials. Many conventional oxidizers such as AP, AN, lithium perchlorate, sodium perchlorate and other chlorates, nitrates or perchlorates are water-soluble and may be of benefit in such a system.

The propellant system of the present invention offers a number of potential benefits. For instance, the propellant system may be used in throttling and start-stop operations, thereby providing additional control and versatility to the rocket. In addition, the components of the composition offer safety in manufacture, shipping and storage compared to other propellant systems for liquid/solid fuel rockets. In particular, the low cost and commercial availability of hydrogen peroxide offer significant advantages to the propellant systems of the present invention.

Although preferred embodiments of the invention have been described herein in detail, it will be understood by those skilled in the art that variations may be made thereto without departing from the spirit of the invention or the scope of the appended claims.

1. A hybrid propulsion system comprising:
a liquid fuel section containing an aqueous solution of hydrogen peroxide and a solid fuel section containing a fuel grain; and
an injector system located between the liquid fuel section and the solid fuel section, said injector system introducing a stream of hydrogen peroxide or decomposed hydrogen peroxide at elevated temperature into the solid fuel section to effect combustion of the fuel grain.

2. The hybrid propulsion system of claim 1 in which the hydrogen peroxide is in a concentration of 50-98 percent by weight.

3. The hybrid propulsion system of claim 2 in which the concentration of hydrogen peroxide is in the range of 70-90 percent by weight.

4. The hybrid propulsion system of claim 1 in which the injector system contains a catalyst for decomposition of hydrogen peroxide to produce a stream of decomposed hydrogen peroxide at elevated temperatures.

5. The hybrid propulsion system of claim 4 in which the catalyst is selected from a group consisting of platinum, silver, platinum or silver coated nickel, and nickel coated with a combination of silver and samarium nitrate.

6. The hybrid propulsion system of claim 1 in which the injector system decomposes said stream of hydrogen peroxide by use of heat.

7. The hybrid propulsion system of claim 1, in which the solid fuel section contains a catalyst to decompose hydrogen peroxide, introduced to said solid fuel sections by said injector.

8. The hybrid propulsion system of claim 7 wherein said catalyst in said solid fuel section is selected from the group consisting of platinum, silver, platinum or silver coated nickel, and nickel coated with a combination of silver and samarium nitrate

9. The hybrid propulsion system of claim 1 in which the aqueous solution of hydrogen peroxide additionally contains at least one of ammonium dinitramide and hydrazinium nitroformate.

10. The hybrid propulsion system of claim 8 in which the amount of ammonium dinitramide or hydrazinium nitroformate is in the range of 5-50% by weight.

11. The hybrid propulsion system of claim 1 in which the aqueous solution of hydrogen peroxide additionally contains an oxidizer in solution or in suspended particulate form.

12. The hybrid propulsion system of claim 9 in which the oxidizer is selected from the group consisting of chlorates, perchlorates and nitrates.

13. The hybrid propulsion system of claim 10, in which the oxidizer is selected from the group consisting of ammonium perchlorate and ammonium nitrate.

14. The hybrid propulsion system of claim 11 in which the aqueous solution of hydrogen peroxide additionally contains stabilizers such as chelating agents in order to increase storage stability.

15. The hybrid propulsion system of claim 1 in which the fuel grain additionally contains a metal.

16. The hybrid propulsion system of claim 14 in which the metal is a hydro-reactive metal.

17. The hybrid propulsion system of claim 16 in which the hydro-reactive metal is selected from the group consisting of aluminum, magnesium, boron, beryllium, lithium and silicon, mixtures thereof, or hydride forms thereof.

18. The hybrid propulsion system of claim 14 in which the metal is in the form of an alloy.

19. The hybrid propulsion system of claim 1 in which the fuel grain contains a solid oxidizer.

20. The hybrid propulsion system of claim 19 in which the solid oxidizer is selected from the group consisting of ammonium perchlorate, ammonium nitrate, hydrazinium nitroformate, ammonium dinitramide, hydroxylammonium nitrate, hydroxylammonium perchlorate, nitronium perchlorate and mixtures thereof.

21. The hybrid propulsion system of claim 1 in which the fuel grain contains an energetic filler.

22. The hybrid propulsion system of claim 21 in which the energetic filler is selected from the group consisting of cyclotrimethylene trinitramine, cyclotetramethylene tetranitramine, hexanitroisoazowurzitane, and mixtures thereof.

23. The hybrid propulsion system of claim 1 in which the fuel grain contains an energetic plasticizer.

24. The hybrid propulsion system of claim 22 in which the energetic plasticizer is selected from the group consisting of butanetriol trinitrate, trimethylolethane trinitrate, triethyleneglycol dinitrate, glycidyl azide plasticizer and mixtures thereof.

25. The hybrid propulsion system of claim 1 in which the fuel grain contains an energetic polymer.

26. The hybrid propulsion system of claim 24 in which the energetic polymer is selected from the group consisting of glycidyl azide polymer, bisazidomethyloxetane/azidomethyl-methoxetane copolymer and nitramethylmethoxetane polymers, and mixtures thereof.

27. The hybrid propulsion system of claim 1 in which the fuel grain contains a ballistic or processing modifier.

28. The hybrid propulsion system of claim 1 in which the fuel grain contains a hydrogen peroxide decomposition catalyst.

29. The hybrid propulsion system of claim 28 in which the decomposition catalyst is selected from the group consisting of potassium permanganate and manganese dioxide.
